(19) United States
(12) Patent Application Publication
(10) Pub. No.: US 2019/0073589 A1
(43) Pub. Date: Mar. 7, 2019

(54) MULTIPLICITY OF INTERSECTING NEURAL NETWORKS OVERLAY WORKLOADS

(71) Applicant: POINTR DATA INC., San Jose, CA (US)

(72) Inventor: Nurettin Burcak Beser, Palo Alto, CA (US)

(21) Appl. No.: 16/117,209

(22) Filed: Aug. 30, 2018

Related U.S. Application Data
(60) Provisional application No. 62/553,130, filed on Sep. 1, 2017.

(51) Int. Cl. G06N 3/08; G06N 3/04

(52) U.S. Cl. CPC G06N 3/08; G06N 3/04

(57) ABSTRACT

A computer architecture for processing an aggregate dataset in an artificial neural network includes a master processor having a primary detector configured to analyze the aggregate dataset and segregate the aggregate dataset into component datasets, and two or more processing nodes in communication with the master processor, each of the processing nodes having secondary detectors configured to analyze the component datasets, wherein the master processor assigns the component datasets to the processing nodes based on processing capabilities of the processing nodes, and wherein the secondary detectors identify data labels associated with the processing nodes by analyzing the component datasets.

### PRIORITY

This application claims priority from U.S. Provisional Pat. No. 62/553,130, entitled “Multiplicity of Intersecting Neural Networks Overlay Workloads (MINNOW)” and filed Sep. 1, 2017.

### FIELD

This disclosure relates to a computer processing architecture, such as suitable for use in a neural network, such as suitable for artificial intelligence processing. Such networks are used, for example, in airplanes, airports, automobiles, boats, cameras, computers, data centers, data gathering devices, drones, factories, gaming applications, medical applications, point-of-sale registers, registration set-ups, robots, shopping, surveillance applications, trade shows, trains, trucks, in workspaces, etc., in industries such as, for example, aerospace, gaming, housing, healthcare, manufacturing, recreation, retail, surveillance, tourism, transportation, travel, etc.

### BACKGROUND

Artificial neural networks (ANNs) comprise interconnected computer processing elements—commonly called nodes—that exhibit behaviors akin to organic brains. Among other things, ANNs can labor under processing burdens, as well as experience degraded performance when processing large blocks of data in a sequential fashion.

Against this background, this application is applicable to, at least, clustered neural network processing methods and systems for processing datasets, such as comprising data from an image, using multi-layered detector systems, methods, and/or mapping structures.

### SUMMARY

In various embodiments, a computer architecture for processing an aggregate dataset in an artificial neural network includes a master processor having a primary detector configured to analyze the aggregate dataset and segregate the aggregate dataset into component datasets; and two or more processing nodes in communication with the master processor, each of the processing nodes having secondary detectors configured to analyze the component datasets; wherein the master processor assigns the component datasets to the processing nodes based on processing capabilities of the processing nodes; and wherein the secondary detectors identify data labels associated with the processing nodes by analyzing the component datasets.

In various embodiments: communication between the master processor and processing nodes is bi-directional; the processing nodes operate independently of one another; the processing nodes train and update independently of one another; the processing nodes operate in parallel; at least one of the processing nodes segregates a component dataset into a further component dataset; the further component dataset decreases inference complexity associated with the further component dataset; and/or the master processor analyzes a subsequent aggregate dataset while the secondary detectors analyze the component datasets.

In various embodiments, a computer-implemented method for processing an aggregate dataset in an artificial neural network includes analyzing an aggregate dataset at a primary detector of a master processor; segregating the aggregate dataset into component datasets based on outputs from the primary detector; assigning the component datasets to two or more processing nodes in electronic communication with the master processor based on processing capabilities of the processing nodes; and analyzing the component datasets at the processing nodes to identify data labels associated with the processing nodes.

In various embodiments, the method further comprises bi-directionally communicating between the master processor and the processing nodes; operating the processing nodes independently of one another; training and updating the processing nodes independently of one another; operating the processing nodes in parallel; segregating a component dataset into a further component dataset; decreasing a number of inferences associated with the further component dataset; and/or analyzing a subsequent aggregate dataset while secondary detectors at the processing nodes analyze the component datasets.

In various embodiments, a non-transitory computer-readable medium embodying program code executable in at least one computing device, the program code, when executed by the at least one computing device, being configured to cause the at least one computing device to at least analyze an aggregate dataset at a primary detector of a master processor; segregate the aggregate dataset into component datasets based on outputs from the primary detector; assign the component datasets to two or more processing nodes in electronic communication with the master processor based on processing capabilities of the processing nodes; and analyze the component datasets at the processing nodes to identify data labels associated with the processing nodes.

In various embodiments: the program code is further configured to operate the processing nodes independently of one another; train and update the processing nodes independently of one another; and/or operate the processing nodes in parallel.

### BRIEF DESCRIPTION OF THE DRAWINGS

The accompanying drawings illustrate various embodiments employing the principles described herein and are a part of the specification. The illustrated embodiments are meant for description only, and they do not limit the scope of the claims, and in which:

FIG. 1 is a simplified illustration of a computer architecture comprising a master processor in communication with one or more processing nodes, in various embodiments;

FIG. 2 is a simplified illustration of computer componentry suitable for use in the computer architecture of FIG. 1, in various embodiments;

FIG. 3 is a simplified illustration of a representative image at an airport, in various embodiments;

FIG. 4 is a simplified illustration of multiple representative objects subject to image processing by a global detector of a unified neural network, in various embodiments;

FIG. 5 is a simplified illustration of multiple representative objects subject to image processing by a global detector and multiple sub-image detectors of a distributed neural network, in various embodiments;

FIG. 6 is a simplified illustration of sequentially processing the multiple objects of FIGS. 4-5, in various embodiments;

FIG. 7 is a simplified illustration of processing the multiple objects of FIGS. 4-5 in parallel, in various embodiments;

FIG. 8 is a simplified illustration of processing multiple aspects of an image in parallel, in various embodiments; and

FIG. 9 is a simplified illustration of a processing method for segregating an aggregate dataset into component datasets and identifying data elements from the component datasets, in various embodiments.

### DETAILED DESCRIPTION

This detailed description of exemplary embodiments references the accompanying drawings, which show exemplary embodiments by way of illustration. While these exemplary embodiments are described in sufficient detail to enable those skilled in the art to practice this disclosure, it should be understood that other embodiments may be realized and that logical changes and adaptations in design and construction may be made in accordance with this disclosure and the teachings herein described without departing from the scope and spirit hereof. Thus, this detailed description is presented for purposes of illustration only and not of limitation.

In accordance with various aspects of this disclosure, systems and methods are described for processing a dataset in an artificial neural network.

Referring generally, an artificial neural network (ANN) is a subset of machine learning, which is a subset of artificial intelligence (AI). ANN's computing systems are not just programmed to perform specific tasks, they are programmed to learn how to perform specific tasks. For example, rather than following task-specific rules, ANNs are programmed to review programmed examples and draw non-programmed inferences from such datasets, in various embodiments. The more examples that an ANN reviews, the deeper its learning is said to be, giving rise to terms such as deep AI and/or deep learning.

Simplified to an exemplary extreme, programmers program ANNs to solve mathematical algorithms, or functions, such as by f(x)=y, in which x is a plurality of examples that an algorithm f is programmed to examine, and y is a result of the analysis. An algorithm is said to train by building the relationship f(x)=y, and when the algorithm is then used to predict an unprogrammed outcome y based on an input x, the algorithm is said to make an inference. In other words, there are, in general, two primary processes involved in machine learning: training and inference. In various embodiments, ANNs learn during training by examining datasets, and ANNs then use that learning from the training to apply and/or draw predictive inferences based on new, unprogrammed datasets. As a result, outputs from ANNs comprise non-linear aggregations—e.g., averages, summations, etc.—from their inputs, enabling ANNs to process unsupervised (i.e., unprogrammed) learning through pattern recognitions and/or the like. In various embodiments, ANNs are thus adaptive models that change their dynamic structures based on internal and external dataflows through the ANNs.

In various embodiments, machine learning relies on centralized models for training, in which groups of machines (e.g., servers and data centers) run computer models against large, centrally-located datasets. When inferences are made, they are performed locally by layered processors, in various embodiments.

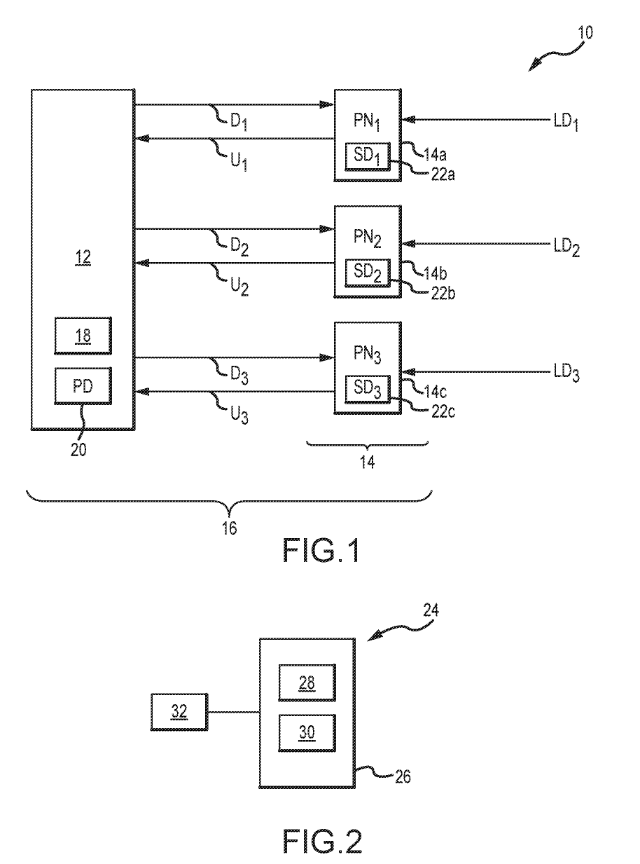

Referring now to FIG. 1, a representative computer architecture 10 comprises, for example, a master processor 12 and a plurality of processing nodes 14 of an artificial neural network 16, the plurality of processing nodes 14 including, for example, a first processing node (PN₁) 14a, a second processing node (PN₂) 14b, and/or a third processing node (PN₃) 14c, etc., such that there are at least two or more processing nodes 14 connected to the master processor 12 within the artificial neural network 16 of the computer architecture 10. In various embodiments, the master processor 12 bi-directionally communicates with at least two or more of the processing nodes 14, such that the master processor 12 maintains, for example, a first download connection D₁ and a first upload connection U₁ with the first processing node (PN₁) 14a, a second download connection D₂ and a second upload connection U₂ with the second processing node (PN₂) 14b, and a third download connection D₃ and a third upload connection U₃ with the third processing node (PN₃) 14c, etc. In addition, the first processing node (PN₁) 14a, for example, trains on a first set of local data LD₁, the second processing node (PN₂) 14b trains on a second set of local data LD₂, and the third processing node (PN₃) 14c trains on a third set of local data LD₃, in various embodiments.

In various embodiments, the master processor 12 contains a data capture device 18, such as a camera (still, video, and/or other), infrared detector, laser and/or lidar detector, metal detector, motion detector, radar detector, speaker, ultrasound detector, and/or other for receiving an aggregate dataset from the computer architecture 10 and/or other. In various embodiments, the master processor 12 controls the data capture device 18, which may also be internal or external to the master processor 12.

In various embodiments, the master processor 12 comprises one or more servers, one or more computer banks, and/or a distributed computing arrangement, such as in a cloud-based arrangement.

In various embodiments, the master processor 12 and/or processing nodes 14 are each individually mapped to a single processing chipset, such as a single graphic processing unit/card.

In various embodiments, the master processor 12 contains a primary detector (PD) 20, and at least two or more of the processing nodes 14 contain secondary detectors (SDs), such as the first processing node (PN₁) 14a comprising a first secondary detector (SD₁) 22a trained on the first set of local data LD₁, the second processing node (PN₂) 14b comprising a second secondary detector (SD₂) 22b trained on the second set of local data LD₂, and/or the third processing node (PN₃) 14c comprising a third secondary detector (SD₃) 22c trained on the third set of local data LD₃, etc.

Referring now to FIGS. 1-2, computer componentry 24, such as the master processor 12 and/or processing nodes 14 of FIG. 1, comprises one or more controllers 26 having one or more internal, computer-based processors 28 operating in conjunction with one or more internal, tangible, non-transitory memories 30 configured to implement digital or programmatic logic, in various embodiments. In various embodiments, for example, the one or more processors 28 comprise one or more of an application specific integrated circuit (ASIC), digital signal processor (DSP), field programming gate array (FPGA), general purpose processor, microprocessor, and/or other programmable logic device (PLD), discrete gate, transistor logic, or discrete hardware component(s), or any various combinations thereof and/or the like, and the one or more tangible, non-transitory memories 30 store instructions therein that are implemented by the one or more processors 28 for performing various functions, such as the systems and methods of the inventive arrangements described herein.

In various embodiments, the components and/or functionality described herein also include computer instructions, programs, and/or software that is or are embodied in one or more external, tangible, non-transitory computer-readable media 32 that are used by the one or more controllers 26. As such, the computer-readable media 32 contains, maintains, and/or stores computer instructions, programs, and/or software that is used by the one or more controllers 26, including physical media, such as, for example, magnetic, optical, and/or semiconductor media, including, for example, flash, magnetic, and/or solid-state devices, in various embodiments. In various embodiments, one or more components described herein are implemented as components, modules, and/or subsystems of a single application, as well as using one computing device and/or multiple computing devices.

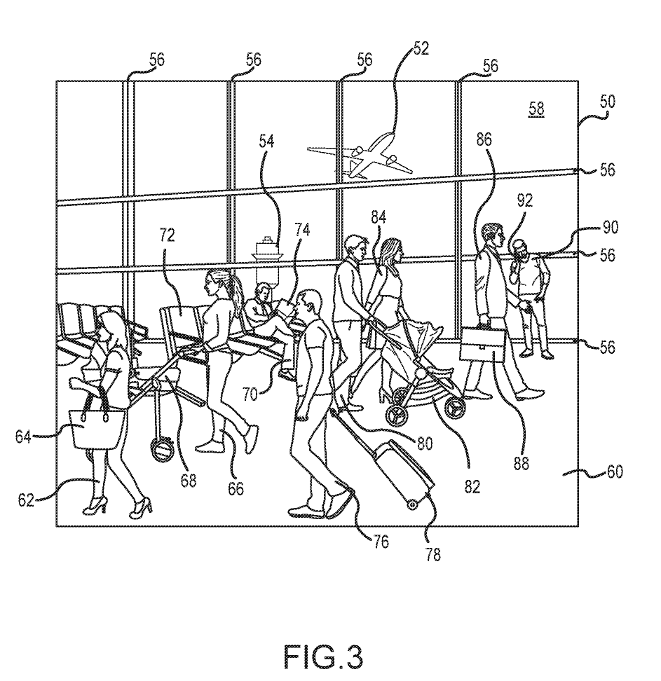

Referring now also to FIGS. 3-9, systems and methods are further described that enable the neural network 16 running on the computer architecture 10 of FIG. 1 to support dataset pattern recognition. More specifically, for example, conventional neural network models extract features from a real-world environment by sequentially sorting through hundreds and/or thousands (or more) of labels in order to draw accurate inferences.

For example, and referring now also to FIG. 3, the master processor 12 of FIG. 1 is trained to identify various objects from a first image 50 utilizing a global detector, such as the primary detector (PD) 20. The representative first image 50 comprises, for example, items such as people, personal items, and/or other, in various embodiments. As a result, as the master processor 12 executes a global pattern recognition routine on an aggregate dataset received from the data capture device 18 of the master processor 12 and processes the dataset through the global detector, it processes at least thousands (or more) of sequential labels in order to be able to draw accurate inferences about the first image 50, in various embodiments.

For example, the master processor 12 of FIG. 1 captures, through its data capture device 18, the first image 50 at an airport, in various embodiments. In such various embodiments, the primary detector 20 is trained to recognize, for example, an airplane 52, a building such as an airport tower 54, window frames 56 of windows 58 intersecting a floor 60, as well as a first woman 62 carrying a purse and/or personal bag 64, a second woman 66 pushing a perambulator 68 in a particular direction, a first man 70 sitting on a bench seat 72 and reading an item 74 such as a book, magazine, newspaper, or other, a second man 76 rolling a carry-on bag 78 in a particular direction, a third man 80 pushing a baby jogger 82 in a particular direction alongside a third woman 84, a fourth man 86 carrying a briefcase 88 and walking in a particular direction, a fifth man 90 standing near the windows 58 and talking on a cell phone 92, etc. As can be seen from this representative first image 50, the neural network 16 of FIG. 1 processes and recognizes a large number of data labels represented in the first image 50—and which changes with different people and different items/objects from one moment to the next, as well as does the overall number of people, number and kinds of items/objects, times of day, etc. (e.g., various environmental factors). As a result, the master processor 12 may be unable to fully process the first image 50, and/or only able to process the first image 50 slowly, in various embodiments. In addition, the master processor 12 may be unable to identify relationships between objects—such as, for example, the fifth man 90 standing near the windows 58 and talking on a cell phone 92.

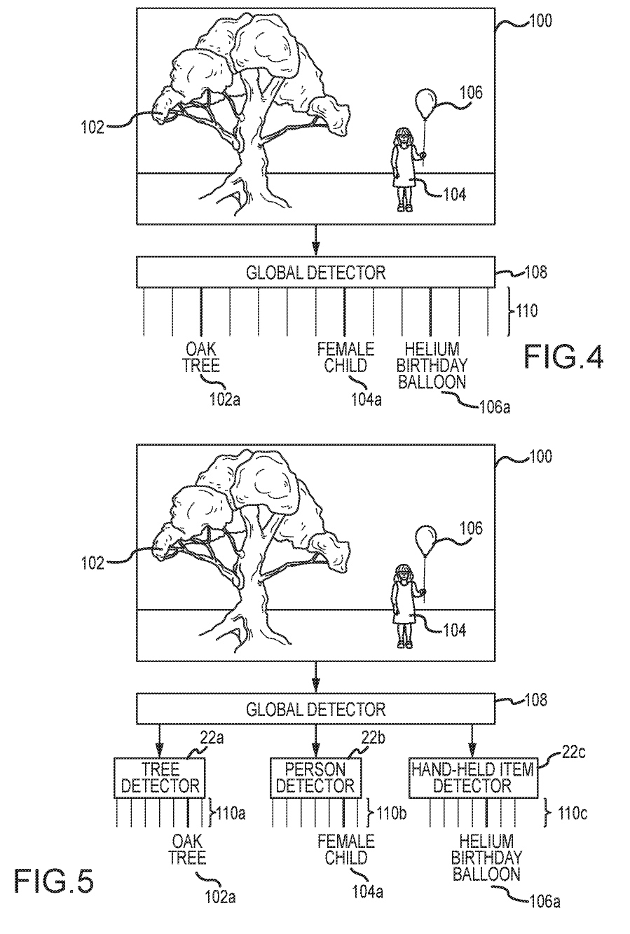

Referring now also to FIG. 4, a representative, simplified second image 100 is presented, in which three relevant objects are present—comprising a tree 102, a person 104, and a hand-held item 106. In the simplified model of the second image 100, the master processor 12 of FIG. 1, implemented as a global detector 108, processes at least thousands (or more) of sequential data labels 110 in order to draw accurate inferences about the second image 100—e.g., that the tree 102 is an oak tree 102a, that the person 104 is a female child 104a, and/or that the hand-held item 106 is a helium birthday balloon 106a, in various embodiments. As can be seen via this representative second image 100, the global detector 108 processes and sorts through immense numbers of possible data labels 110 about the second image 100 (e.g., various types of trees, people, hand-held items, etc.) in order to correctly infer that the second image 100 comprises the oak tree 102a, the female child 104a, and the helium birthday balloon 106a.

In addition, if the first set of local data LD₁ from FIG. 1 is trained on trees, and the second set of local data LD₂ from FIG. 1 is trained on people, and the third set of local data LD₃ from FIG. 1 is trained on hand-held items, and an update is desired and/or needed for any or all of them, then the master processor 12 re-trains on the full model, comprising all of the data labels 110 corresponding to the second image 100.

Referring now also to FIG. 5, the simplified second image 100 is again presented, in which the three relevant objects are again present—the tree 102, the person 104, and the hand-held item 106. In this embodiment, however, the master processor 12 of FIG. 1 is again implemented as the global detector 108, but it no longer draws the conclusions (e.g., inferences) that the tree 102 is the oak tree 102a, that the person 104 is the female child 104a, or that the hand-held item 106 is the helium birthday balloon 106a, in various embodiments. Rather, once the master processor 12, implemented as the global detector 108, detects that the second image 100 comprises a tree 102, a person 104, and a hand-held item 106, it passes additional processing to the processing nodes 14 of FIG. 1, such as to the first processing node (PN₁) 14a, the second processing node (PN₂) 14b, and/or the third processing node (PN₃), in various embodiments. The distributed processing power of each processing node 14 is then used to draw the deeper conclusions about the second image 100.

For example, the first processing node (PN₁) 14a utilizes its first secondary detector (SD₁) 22a, implemented as a tree detector, to determine that the type of tree 102 in the second image 100 is the oak tree 102a (among many images and/or types of possible trees), including analyzing first data labels 110a (e.g., tree labels) assigned to the first processing node (PN₁) 14a by the master processor 12, in various embodiments. Likewise, the second processing node (PN₂) 14b utilizes its second secondary detector (SD₂) 22b, implemented as a person detector, to determine that the type of person 104 in the second image 100 is the female child 104a (among many images and/or types of possible people), including analyzing second data labels 110b (e.g., people labels) assigned to the second processing node (PN₂) 14b by the master processor 12, in various embodiments. Likewise, the third processing node (PN₃) 14c utilizes its third secondary detector (SD₃) 22c, implemented as a hand-held item detector, to determine that the type of hand-held item 106 in the second image 100 is the helium birthday balloon 106a (among many images and/or types of hand-held items), including analyzing third data labels 110c (e.g., hand-held item labels) assigned to the third processing node (PN₃) 14c by the master processor 12, in various embodiments.

In addition, if the first set of local data LD₁ from FIG. 1 is trained on trees, and the second set of local data LD₂ from FIG. 1 is trained on people, and/or the third set of local data LD₃ from FIG. 1 is trained on hand-held items, and an update is desired and/or needed for any or all of them, then the master processor 12 re-trains only the processing node(s) 14 affected by the revised model(s), such as the first data labels 110a (e.g., the tree labels), the second data labels 110b (e.g., the people labels), and/or the third data labels 110c (e.g., the hand-held item labels), in various embodiments.

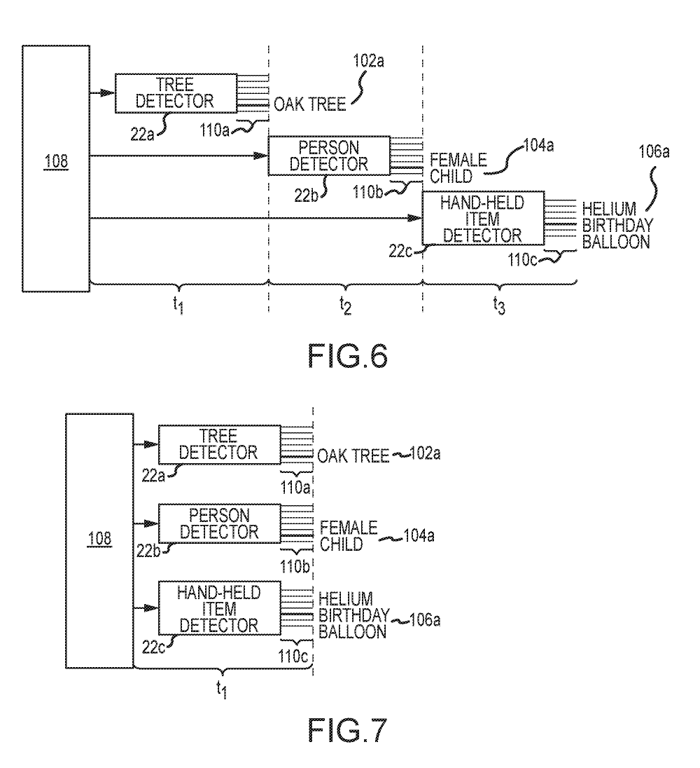

In addition, and referring now also to FIG. 6, the neural network 16 of FIG. 1 draws the inferences from the second image 100 of FIGS. 4-5 sequentially, such as by recognizing that the tree 102 is the oak tree 102a at a first time (t₁), followed by then recognizing that the person 104 is the female child 104a at a subsequent, second time (t₂), followed by then recognizing that the hand-held item 106 is the helium birthday balloon 106a at a subsequent, third time (t₃), in various embodiments. As such, when the neural network 16 is implemented as a unified neural network 16, it processes the second image 100 using the global detector 108, and then serially using each of the tree detector 22a, the person detector 22b, and the hand-held item detector 22c sequentially, according to a programmed order—reviewing all the data labels 110 in a pre-determined order in which the neural network 16 is trained to draw inferences.

In addition, and referring now also to FIG. 7, the neural network 16 of FIG. 1 draws the inferences from the second image 100 of FIGS. 4-5 in parallel, such as by recognizing that the tree 102 is the oak tree 102a, that the person 104 is the female child 104a, and that the hand-held item 106 is the helium birthday balloon 106a at approximately a same time (t₁), in various embodiments. As such, when the neural network 16 is implemented as a distributed neural network 16, it processes the second image 100 using the global detector 108, and then each of the tree detector 22a, the person detector 22b, and the hand-held item detector 22c in parallel—reviewing the first data labels 110a, the second data labels 110b, and the third data labels 110c at effectively a same time, all via the processing power of the independent and individual processing nodes 14 of the neural network 16. As a result, the computer architecture 10 draws faster inferences when the processing nodes 14 operate in parallel in order to process, for example, the first image 50 and/or the second image 100, in various embodiments. In addition, the global detector 108 can process a subsequent and/or different image while the processing nodes 14 are operating in parallel as well, further decreasing cycle time for the computer architecture of FIG. 1.

As described above, the master processor 12 pre-processes an aggregate dataset captured by a data capture device 18 to then segregate the aggregate database into component/constituent databases that are then individually processed by the processing nodes 14 of the neural network 16. By distributing shared processing to the processing nodes 14, the computer architecture 10 is able to draw faster inferences regarding individualized components of the aggregate database. In addition, if an individual processing node 14 needs to be individually updated and re-trained using constituent local data, the master processor 12 and other processing nodes 14 are unaffected by the local event. In FIG. 5, for example, this can enable the tree detector 22a to be trained and/or re-trained independently of training and/or re-training the person detector 22b, in various embodiments. Independent and/or separate training and/or re-training are thereby enabled.

In addition, if one processing node 14 is unable and/or slow to draw an inference from a particular image, such as the first image 50 and/or the second image 100, then the other processing nodes 14 are still able to draw inferences in accordance with their individualized processing capacities and local datasets LDs, in various embodiments.

As described above, the master processor 12 analyzes the aggregate data captured by the data capture device 18 and performs subsequent actions based on its initial analysis of the dataset. For example, the master processor 12 of the neural network 16 of the computer architecture 10 of FIG. 1 further controls the processing nodes 14 to transmit various portions of the aggregate dataset, or processed versions of portions of the dataset, to the processing nodes 14 for additional processing. Each of the master processor 12 and/or processing nodes 14 execute separate artificial intelligence algorithms, in various embodiments. In various embodiments, the computer architecture 10 comprises at least two or more of the processing nodes 14 for distributing at least some of the data analysis of a captured dataset.

Each of the processing nodes 14 receives its component dataset (raw or processed) distributed from the master processor 12 via, for example, download links, such as the first download connection D₁ of the first processing node (PN₁) 14a, the second download connection D₂ of the second processing node (PN₂) 14b, and/or the third download connection D₃ of the third processing node (PN₃) 14c, etc., in various embodiments.

In various embodiments, each of the processing nodes 14 analyzes the respective component dataset that it received from the master processor 12 according to its own processing routines and data labels assigned to it.

In various embodiments, each of the processing nodes 14 transmits its inferences back to the master processor 12 via, for example, upload links, such as the first upload connection U₁ of the first processing node (PN₁) 14a, the second upload connection U₂ of the second processing node (PN₂) 14b, and/or the third upload connection U₃ of the third processing node (PN₃) 14c, etc.

In addition, the first processing node (PN₁) 14a, for example, trains on the first set of local data LD₁, the second processing node (PN₂) 14b trains on the second set of local data LD₂, and the third processing node (PN₃) 14c trains on the third set of local data LD₃, in various embodiments.

Referring again to FIGS. 1-5, the neural network 16 is trained to identify various objects from datasets, such as corresponding to the first image 50 and/or the second image 100, in various embodiments, through the global detector 108, which pre-filters the aggregate datasets into component datasets. As a result, utilizing the computer architecture 10 of FIG. 1, various outputs from the global detector 108 are mapped, for example, to the first processing node (PN₁) 14a running a tree detector routine at a tree detector 22a to determine a type of tree 102 as an oak tree 102a, the second processing node (PN₂) 14b running a person detector routine at a person detector 22b to determine a type of person 104 as a female child 104a, and/or the third processing node (PN₃) 14c running a hand-held item detector routine at a hand-held item detector 22c to determine a type of hand-held object 106 as a helium birthday balloon 106a, each running in parallel on the computer architecture 10, in various embodiments.

As described, rather than running an entire dataset of hundreds and/or thousands (or more) of labels 110 sequentially through the global detector 108, as in FIG. 4, the master processor 12 partitions the aggregate dataset and allocates parts of the dataset to the plurality of processing nodes 14 in parallel, such as transmitting component/constituent parts to the first processing node (PN₁) 14a, the second processing node (PN₂) 14b, and/or the third processing node (PN₃) 14c, each running routines independently and/or simultaneously, in various embodiments. Accordingly, the master processor 12 pre-sorts the image, such as the first image 50 and/or the second image 100, into smaller datasets for distribution to the two or more processing nodes 14. As such, dataset pattern recognition routines run in parallel within the neural network 16 of the computer architecture 10, in various embodiments.

In various embodiments, inferences from the primary detector 20 trigger processing at the downstream secondary detectors (SDs) 22. As a result, when the plurality of processing nodes 14 execute routines in parallel, the master processor 12 is able to discern the objects in the datasets with higher confidence/correlation and/or in less time, particularly when compared to processing a dataset using the global detector 108 to linearly and/or sequentially review all of the data labels 110 of FIG. 4 that the artificial neural network 16 is trained to recognize.

Since the first processing node (PN₁) 14a, the second processing node (PN₂) 14b, and/or the third processing node (PN₃) 14c are independently run by the master processor 12, they update independently and in parallel on the computer architecture 10, in various embodiments.

In various embodiments, each processing node 14 can also act as a sub-global detector 108 as well, further sending component data elements to additional processing nodes 14 for continued distribution and processing as well. For example, in the second image 100 of FIG. 5, the tree detector 22a could have passed the tree 102 determination through several layers of filtering and/or processing (e.g., monopodials, simpodials, etc.) to determine that the tree 102 was the oak tree 102a. Likewise, the person detector 22b could further process the female child 104a determination to ascertain that the female child 104a is likely between 5-10 years old, or has red hair, or braces, etc. Likewise, the hand-held item detector 22c could have passed the hand-held item 106 determination through several layers of filtering and/or processing to determine not just the hand-held item 106 was a balloon, but that the balloon was a helium balloon (such as by analyzing the string and/or elevation between the person 104 and the hand-held item 106) and/or that the balloon was a birthday balloon (such as by analyzing words on a surface of the hand-held item). Further sub-filtering/processing can be directed by the global detector 108 and/or by the processing nodes 14. With each additional classification, the complexity of inference for subsequent classifications decreases.

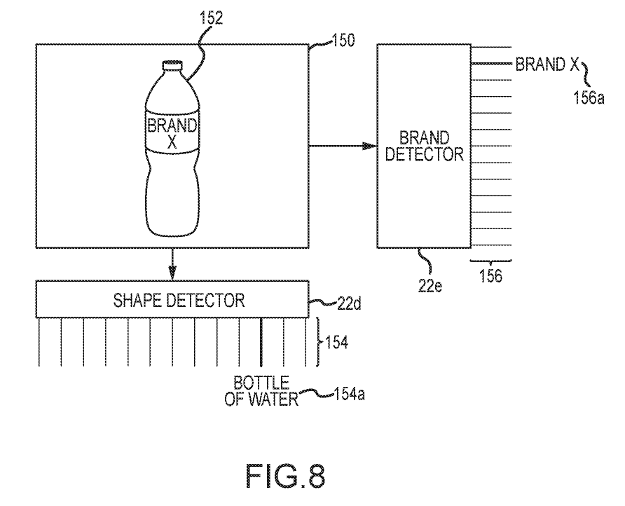

Referring now also to FIG. 8, a third simplified image 150 is presented, comprising, for example, a grocery item 152 at a check-out station, in various embodiments. If a neural network 16 is implemented as a distributed neural network 16, it can process the third image 150 using independent processing nodes 14, such as including a shape detector 22d and a brand detector 22e, in various embodiments. If the computer architecture 10 of FIG. 1 is configured for use, for example, in the grocery store, then the shape detector 22d may be trained to recognize various item types at a check-out station, such as a bottle of water 154a, including relative to other images and/or types of possible items that may be found at the grocer, including analyzing item type data labels 154 (e.g., bottles of soda, cake mixes, eggs, flowers, jugs of milk, etc.) assigned to the shape detector 22d as a processing node 14, in various embodiments. Likewise, the brand detector 22e may be trained to recognize various brands at the check-out station, such as Brand X 156a, including relative to other images and/or brands that may be found at the grocer, including analyzing brand data labels 156 (e.g., Brands A, B, C, etc.) assigned to the brand detector 22e as a processing node 14, in various embodiments.

When operating in parallel, the processing nodes 14 thus recognize the grocery item 152 as a bottle of water 154a by Brand X 156a, which is, or at least may be, associated with a particular price (or other) for that particular grocery item 152, in various embodiments. The determinations of the independent processing nodes 14 intersect to draw a multi-layered conclusion as to the likely identity of the grocery item 152, in various embodiments. This allows the master processor 12 at the grocery store to not have to sequentially run through all the data labels for the food and/or items available at the grocer. And if an inconsistency arises between data label conclusions, then the master processor 12 can run a sub-routine to rectify, in various embodiments.

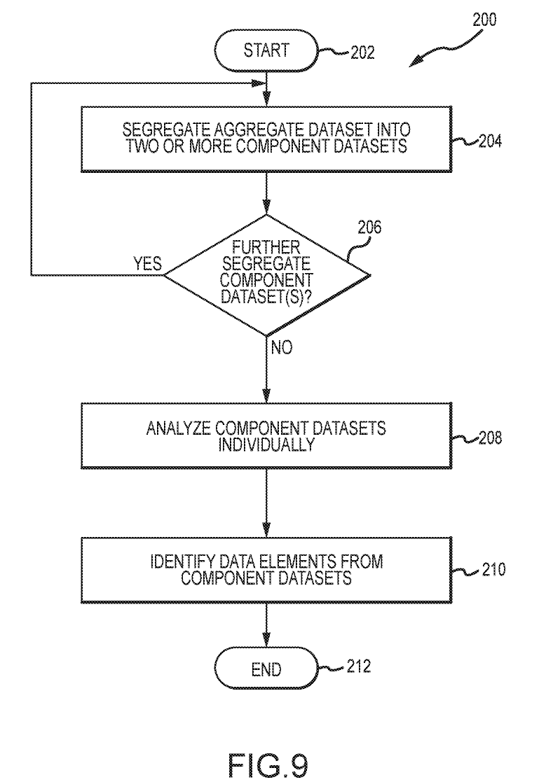

Referring now also to FIG. 9, a computer-implemented method 200 begins at a step 202, after which an aggregated dataset is segregated into two or more component datasets at a step 204. Thereafter, a decision is made whether to further segregate the component datasets into additional datasets, such as at a step 206. If a decision is made to further segregate the component datasets into additional datasets at step 206, then the control returns to step 204, in various embodiments. Alternatively, if a decision is made to not further segregate the component datasets into additional datasets at step 206, then the control passes to step 208, at which the component datasets are analyzed individually, in various embodiments. Thereafter, individual data elements are identified from the component datasets at a step 210, after which the method 200 ends at step 212.

In accordance with the description herein, technical benefits and effects of this disclosure include efficiently processing a dataset in an artificial neural network, such as using a global detector receiving an aggregate dataset to distribute parts of that dataset to two or more processing nodes for individually analyzing the parts of the dataset more quickly and efficiently and with greater accuracy than the global detector individually processing sequential data labels.

Advantages, benefits, improvements, and solutions, etc. have been described herein with regard to specific embodiments. Furthermore, connecting lines shown in the various figures contained herein are intended to represent exemplary functional relationships and/or physical couplings between the various elements. It should be noted that many additional and/or alternative functional relationships or physical connections may be present in a practical system. However, the advantages, benefits, improvements, solutions, etc., and any elements that may cause any advantage, benefit, improvement, solution, etc. to occur or become more pronounced are not to be construed as critical, essential, or required elements or features of this disclosure.

The scope of this disclosure is accordingly to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one, and that reference to an item in the singular may also include the item in the plural, and vice-versa. All ranges and ratio limits disclosed herein may be combined.

Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C. Different cross-hatching may be used throughout the figures to denote different parts, but not necessarily to denote the same or different materials. Like depictions and numerals also generally represent like elements.

The steps recited in any of the method or process descriptions may be executed in any order and are not necessarily limited to the order presented. Furthermore, any reference to singular elements, embodiments, and/or steps includes plurals thereof, and any reference to more than one element, embodiment, and/or step may include a singular one thereof. Elements and steps in the figures are illustrated for simplicity and clarity and have not necessarily been rendered according to any particular sequence. For example, steps that may be performed concurrently or in different order are only illustrated in the figures to help to improve understanding of embodiments of the present, representative disclosure.

Any reference to attached, connected, fixed, or the like may include full, partial, permanent, removable, temporary and/or any other possible attachment option. Additionally, any reference to without contact (or similar phrases) may also include reduced contact or minimal contact. Surface shading lines may be used throughout the figures to denote different areas or parts, but not necessarily to denote the same or different materials. In some cases, reference coordinates may or may not be specific to each figure.

Apparatus, methods, and systems are provided herein. In the detailed description herein, references to “one embodiment,” “an embodiment,” “various embodiments,” etc., indicate that the embodiment described may include a particular characteristic, feature, or structure, but every embodiment may not necessarily include this particular characteristic, feature, or structure. Moreover, such phrases may not necessarily refer to the same embodiment. Further, when a particular characteristic, feature, or structure is described in connection with an embodiment, it is submitted that it is within the knowledge of one skilled in the art to affect such characteristic, feature, or structure in connection with other embodiments, whether or not explicitly described. After reading the description, it will be apparent to one skilled in the relevant art(s) how to implement this disclosure in alternative embodiments.

Furthermore, no component, element, or method step in the present disclosure is intended to be dedicated to the public regardless of whether the component, element, or method step is explicitly recited in the claims. No claim element is intended to invoke 35 U.S.C. § 112(f) unless the element is expressly recited using the phrase “means for.” As used herein, the terms “comprises,” “comprising,” or any other variation thereof, are intended to cover a non-exclusive inclusion, such that an apparatus, article, method, or process that comprises a list of elements does not include only those elements, but it may also include other elements not expressly listed or inherent to such apparatus, article, method, or process.

What is claimed is:

1. A computer architecture for processing an aggregate dataset in an artificial neural network, comprising:
a master processor having a primary detector configured to analyze the aggregate dataset and segregate the aggregate dataset into component datasets; and
two or more processing nodes in communication with the master processor, each of the processing nodes having secondary detectors configured to analyze the component datasets;
wherein the master processor assigns the component datasets to the processing nodes based on processing capabilities of the processing nodes; and
wherein the secondary detectors identify data labels associated with the processing nodes by analyzing the component datasets.

2. The computer architecture for processing the aggregate dataset in the artificial neural network of claim 1, wherein communication between the master processor and processing nodes is bi-directional.

3. The computer architecture for processing the aggregate dataset in the artificial neural network of claim 1, wherein the processing nodes operate independently of one another.

4. The computer architecture for processing the aggregate dataset in the artificial neural network of claim 1, wherein the processing nodes train and update independently of one another.

5. The computer architecture for processing the aggregate dataset in the artificial neural network of claim 1, wherein the processing nodes operate in parallel.

6. The computer architecture for processing the aggregate dataset in the artificial neural network of claim 1, wherein at least one of the processing nodes segregates a component dataset into a further component dataset.

7. The computer architecture for processing the aggregate dataset in the artificial neural network of claim 6, wherein the further component dataset decreases inference complexity associated with the further component dataset.

8. The computer architecture for processing the aggregate dataset in the artificial neural network of claim 1, wherein the master processor analyzes a subsequent aggregate dataset while the secondary detectors analyze the component datasets.

9. A computer-implemented method for processing an aggregate dataset in an artificial neural network, comprising:
analyzing an aggregate dataset at a primary detector of a master processor;
segregating the aggregate dataset into component datasets based on outputs from the primary detector;
assigning the component datasets to two or more processing nodes in electronic communication with the master processor based on processing capabilities of the processing nodes; and
analyzing the component datasets at the processing nodes to identify data labels associated with the processing nodes.

10. The computer-implemented method for processing the aggregate dataset in the artificial neural network of claim 9, further comprising:
bi-directionally communicating between the master processor and the processing nodes.

11. The computer-implemented method for processing the aggregate dataset in the artificial neural network of claim 9, further comprising:
operating the processing nodes independently of one another.

12. The computer-implemented method for processing the aggregate dataset in the artificial neural network of claim 9, further comprising:
training and updating the processing nodes independently of one another.

13. The computer-implemented method for processing the aggregate dataset in the artificial neural network of claim 9, further comprising:
operating the processing nodes in parallel.

14. The computer-implemented method for processing the aggregate dataset in the artificial neural network of claim 9, further comprising:
segregating a component dataset into a further component dataset.

15. The computer-implemented method for processing the aggregate dataset in the artificial neural network of claim 14, further comprising:
decreasing a number of inferences associated with the further component dataset.

16. The computer-implemented method for processing the aggregate dataset in the artificial neural network of claim 14, further comprising:
analyzing a subsequent aggregate dataset while secondary detectors at the processing nodes analyze the component datasets.

17. A non-transitory computer-readable medium embodying program code executable in at least one computing device, the program code, when executed by the at least one computing device, being configured to cause the at least one computing device to at least:
analyze an aggregate dataset at a primary detector of a master processor;
segregate the aggregate dataset into component datasets based on outputs from the primary detector;
assign the component datasets to two or more processing nodes in electronic communication with the master processor based on processing capabilities of the processing nodes; and
analyze the component datasets at the processing nodes to identify data labels associated with the processing nodes.

18. The non-transitory computer-readable medium of claim 17, wherein the program code is further configured to:
operate the processing nodes independently of one another.

19. The non-transitory computer-readable medium of claim 17, wherein the program code is further configured to:
train and update the processing nodes independently of one another.

20. The non-transitory computer-readable medium of claim 17, wherein the program code is further configured to:
operate the processing nodes in parallel.
